(19) United States
(12) Patent Application Publication
(10) Pub. No.: US 2023/0227288 A1
(43) Pub. Date: Jul. 20, 2023

(54) ELEVATOR AND ESCALATOR MONITORING ARRANGEMENT

(71) Applicant: KONE Corporation, Helsinki (FI)

(72) Inventors: Santtu KOSKINEN, Helsinki (FI); Mikko MATTILA, Helsinki (FI); Mikko HEISKANEN, Helsinki (FI); Mikko PIIRONEN, Helsinki (FI); Ari KOIVISTO, Helsinki (FI); Mika BELOV, Helsinki (FI)

(73) Assignee: KONE Corporation, Helsinki (FI)

(21) Appl. No.: 18/119,335

(22) Filed: Mar. 9, 2023

Related U.S. Application Data
(63) Continuation of application No. PCT/FI2020/050669, filed on Oct. 12, 2020.

(51) Int. Cl. B66B 5/00; B66B 5/02

(52) U.S. Cl. CPC B66B 5/0018; B66B 5/0037; B66B 5/021

(57) ABSTRACT

A user interface shows status of devices of an elevator and escalator arrangement. The status is based on holistic measurement approach wherein measurements for one or more indicator values are made continuously and compared against reference values. The difference between the measured and reference values are shown in a user interface for indicating that status of individual components and the overall system.

### DESCRIPTION OF BACKGROUND

The following disclosure relates to managing elevators and escalators. Particularly the disclosure relates to methods and arrangements for monitoring performance of an elevator and escalator system and detecting a decrease in the performance.

Modern elevators are so called connected devices. Modern elevators do have a plurality of peripheral devices that are or can be connected to each other using different networking solutions. For example, an elevator car may comprise a control panel, emergency phone, information screen, security cameras, network hotspot and other similar peripheral devices that are connected to a data communication network. In addition to the peripheral devices located in the elevator car further connected peripheral devices may be located at landing floors, door frames, hoisting machine and similar. Thus, there is a large number of different peripheral devices that may require a network connection.

Fluent operation of an elevator and escalator system is depending on how well different peripheral devices and other components perform tasks assigned to them. For example, if an elevator comprises a network connected destination control system, the overall efficiency of the elevator is partially depending on the control panel of the destination control system, group controller controlling the destination control system, controller operating the elevator, hoisting machine, operation of landing doors used during ride and so on. Each of the steps associated with one journey may be delayed only very short periods. However, when they are accumulated together the time delay may be significant and the user experience provided to the passengers is reduced.

Many of the peripheral devices and components operate independently. They do have their own software and communicate with other peripheral devices and components by sending and receiving messages. For example, a control panel of a destination control system may request the user to indicate a floor and a number of passengers using a touch screen having a software implemented user interface. The user interface receives the indication and sends it further. However, if the user interface is operating slowly, for example, because of a software fault or old hardware that doesn't have enough computing power to match all new software updates or other increased need of computing power, the indication is received later at the controller and the delay goes through the whole service chain. There is a plurality of possible reasons for slow operation. For example, the operation may be slowed down because of a temporary load conditions, cyber-attacks, wrong configuration and similar. Some of the reasons are such that they require attention and some of them are natural and can go away on their own. This reduces the people flow experience for the users and also reduces the throughput of the overall system. If the throughput is not the best possible this may cause queues at the building and in order to avoid the queues, more elevators need to be constructed. However, the area required by elevators is expensive and building owners are always wishing to improve the throughput. Furthermore, more efficient operation of elevators and escalators may facilitate more efficient allocation of passengers, which will reduce the number of needed journeys and may lead into energy savings.

### SUMMARY

In the following disclosure a user interface showing status of devices of an elevator and escalator arrangement is disclosed. The status is based on holistic measurement approach wherein measurements for one or more indicator values are made continuously and compared against reference values. The reference values can be set or they can be adaptive. The adaptive values may be learned using a machine learning arrangement or using conventional adjustment methods. The difference between the measured and reference values are shown in a user interface for indicating that status of individual components and the overall system.

In an aspect a method for measuring the state of an elevator and escalator arrangement is disclosed. The method comprises: determining a reference value for an indicator value; transmitting a message to a recipient component; receiving a response to the transmitted message; measuring the indicator value based on the received response; comparing the measured indicator value with the reference value, wherein the comparison result is indicative of the state of a component in the elevator and escalator arrangement; and displaying the comparison result in a user interface.

In an implementation the indicator value is a network delay between the requesting component and the serving component. In an implementation the indicator value is the delay required to perform a requested task at the serving component. In an implementation the indicator value is representing the availability of the component. In an implementation the indicator value is the resource load at the serving component. In an implementation the method further comprises displaying the comparison result as a relative deviation from the reference value. In an implementation the method further comprises comparing the comparing result with a threshold and as a response to exceeding the threshold, triggering an event. In an implementation the event is one of the following: a maintenance call or an alert.

In an aspect a computer program product is disclosed. The computer program product comprises computer program code, which is configured to cause performing a method as described above, when executed by a computing device. In an aspect a system comprising a circuitry for executing computer programs is disclosed. The circuitry is configured to perform a method as described above.

The aspects and embodiments above provide an efficient way of measuring a complete elevator, escalator and other transportation infrastructure. When the measurement results are shown in a user interface as described above a maintenance person or other control person can immediately see the status of the infrastructure arrangement and do the necessary changes in order to provide fluent operation of the arrangement. The reference values mentioned above provide an efficient way to detect the deviations from the normal state and when the reference values are learned using a machine learning arrangement the reference values correspond with the true values for normal operation.

### BRIEF DESCRIPTION OF THE DRAWINGS

The accompanying drawings, which are included to provide a further understanding of the monitoring of elevator and escalator arrangement and constitute a part of this specification, illustrate examples and together with the description help to explain the principles of monitoring the elevator and escalator arrangement. In the drawings:

FIG. 1 is a block diagram of an example of an elevator and escalator control arrangement with attached devices,

FIG. 2 shows examples of signaling for measuring indicator values, and

FIG. 3 shows an example of a method for monitoring elevator and escalator arrangement.

### DETAILED DESCRIPTION

Reference will now be made in detail to the examples, which are illustrated in the accompanying drawings.

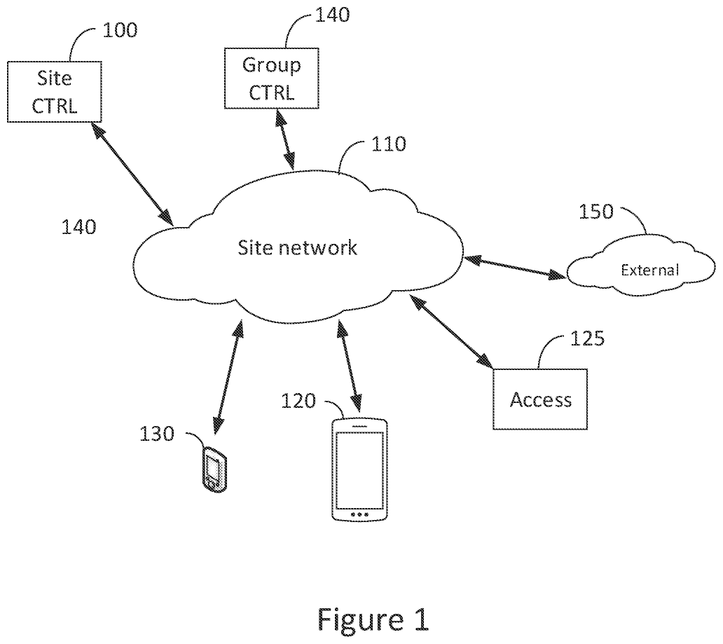

In FIG. 1 discloses a block diagram of an example of an elevator and escalator control arrangement. In the example of FIG. 1 the arrangement comprises a system controller 100 that is connected to the site network 110. The example of FIG. 1 further shows an access terminal 120, an access control system 125, a destination control system terminal and an elevator group controller 140. These are connected to the site network 110. The site network is further connected to an external network 150. The external network is used to illustrate a network for reaching one or more remotely located external services. The external network may be the Internet, a building network, a cloud service or similar.

In the example of FIG. 1 the system controller 100 is an ordinary computer located at a controlling facility. Thus, it comprises a memory, a processor, a display, network connection and similar means that are commonly used with a computer. Instead of an ordinary computer the system controller 100 may be a portable computer, tablet computer or a mobile device that is connected to a network using wireless means. In the example of FIG. 1 the system controller 100 is connected to a site network. The direct connections between the system controller 100 and other devices are illustrating a direct connection that may also be organized through the site network 110. However, in some arrangements also direct connections using a wireless networking technology may be beneficial.

In the example of FIG. 1 a site network 110 is shown as a connecting element between the system controller 100 and attached peripheral devices and other components. The site network may be a dedicated physical network that has been constructed for elevator and escalator arrangements. Instead of a dedicated physical network a building network may be used to carry the site network 110. In such cases it is common that the site network 110 is privatized or virtualized so that devices attached to the site network cannot be accessed without authorization. In both cases there may be an access point or an integration point to external networks 150. In the example of FIG. 1 the system controller 100 is connected directly to the site network 110, however, this is only an example and the system controller 100 may be connected to the site network through the external network access point or integration point 150.

In the example of FIG. 1 an access terminal 120 is shown. The access terminal is an entity that controls access to a building or a part of the building. This may be implemented as an access gate, electric lock, elevator controls or similar. The purpose of an access terminal is to identify a person requesting the access. This is commonly done using a keycard, key fob or similar electric key that is introduced at the access terminal 120. The access terminal 120 communicates with the introduced electric key. When the access terminal has identified the electric key, it may send the identification to an access control system 125, which then responses to the access terminal by providing information about the access granted to the person carrying identified the identified key. The access terminal 120 has means for measuring the time taken for receiving the response from the access control system 125. This time is important because if it takes too long the quality of user experience is reduced and possibly also the passenger flows are slowed. The measured time is sent to the system controller 100 for further processing. The identity check may include additional steps, such as request entering a personal identification number or a password. In such case the time taken by additional steps is depending on the actions of the identified person and these periods should be excluded from the measurements.

The destination control system terminal 130 is used for indicating a destination for a journey. Optionally the destination control system may request the number of passengers. In the example a destination control system terminal 130 transmits the made calls to the group controller 140 that allocates a journey according to the received call. After the allocation the group controller 140 controls the elevator system according to the placed calls. When placing a call, it is possible to measure, for example, the time taken from the call to the finalized allocation. This time can be used as an indicator to be collected at the system controller 100. A second indicator is how long it takes that the elevator car arrives at the place of call. This, naturally, depends also on current locations of elevator cars, however, it may also be used a longer-term indicator, which is also sent to the system controller. The indicators mentioned above are just examples and other indicators may be used.

The system controller 100 is typically a computing device including a display, which may be a touch screen. The controller receives the collected information and provides the information to a user of the system controller 100 in a form of a user interface displaying the current status of the elevator and escalator system with respective delay key performance indicators. The collected key performance indicators, such as the time taken for allocation, can be shown to the user in absolute values or as a relative difference between the current measured values and a reference value. The reference value, for example, for allocating an elevator is set to the arrangement. The reference value may be based on actual measurements or a simulation and it may be changed, for example, after changes in the elevator arrangement. The reference value typically represents a value that should be normal in ordinary use. Thus, it doesn't need to be the best possible value as some variation is expected also even without problems. However, if the allocation time increases significantly the additional delay may be an indication of a problem that reduces the efficiency of the whole system. When the increase is shown in the user interface of the system controller 100 it is possible to notice additional delay.

In the above an arrangement for monitoring an elevator and escalator arrangement is disclosed. The expression monitoring in the context of this application to be a process of collecting information continuously or at requested time periods by using appropriate measurement means. The collected information is then analyzed and/or displayed in a user interface so that a maintenance person can see it.

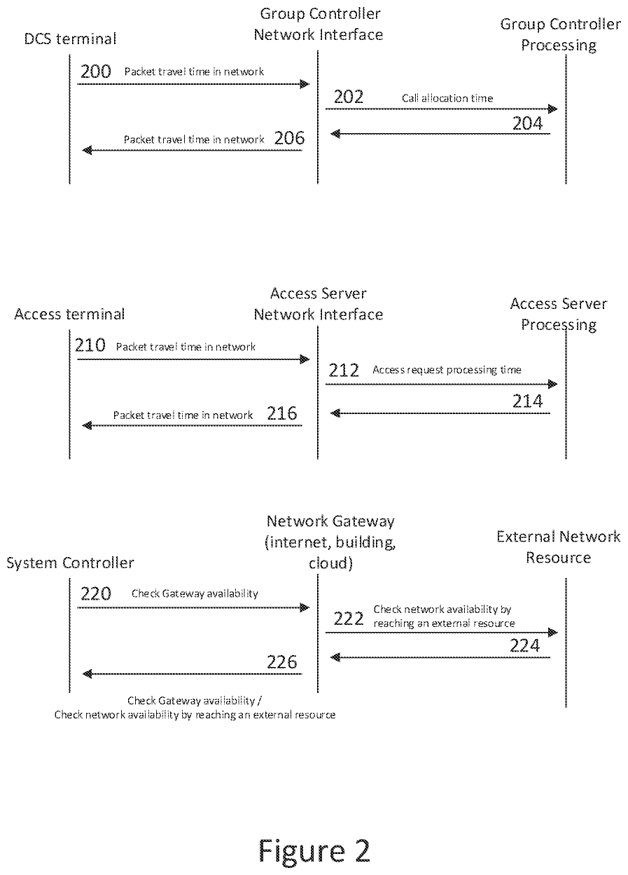

FIG. 2 discloses three examples of a signaling chart for measuring a key performance indicator. In the first signaling chart a destination control system terminal sends a message 200 to the group controller for allocating a call. The group controller has a network interface that receives the message 200. The group controller network interface then sends an internal message 202 to the group controller processing mechanism, which allocates a call and responds to message 202 by transmitting a message 204. The group controller network interface then sends a message 206 to the destination control system terminal. When the message 206 is received at the destination control system terminal, the time taken for all of these may be computed, which then corresponds with the time that the complete allocation process has taken. This time may be used as a key performance indicator. Furthermore, the time taken by messages 202 and 204 may also be computed. This value represents the time taken for allocation without network delays. Furthermore, accordingly the time of the network delays can be computed as time taken by messages 200 and 206. In the example, in addition to the propagation time, the times also include the processing of the actual task, for example, allocation of the call. Additionally, it is possible to measure how long it takes for the elevator to arrive at the called floor.

In the second chart an access terminal sends a message 210 requesting access to the access server. The access server receives the message 210 at the network interface and provides an internal message 212 to the access server processing. The access server comprises, for example, a processor and a data base for verifying the access. The access server responds to the request by transmitting a message 214. Finally, a message 2165 is sent to the access terminal. Similarly, to the example of the destination control system explained above the network propagation time and access processing time can be computed separately or together depending on which key performance indicator the user is wishing to see.

In the third signaling chart system controller sends a message 220 to an external network resource. The network gateway, for example, which connects the site network to the Internet, receives the message 220. The network gateway sends a message 222 to the external network resource, which responds by message 224. The network gateway receives the message 224 and then transmits a final response to the system controller using a message 226. In the last example the network propagation time is not limited to the messages 220 and 226 but there may be a significant network propagation time also in messages 222 and 224. Messages 222 and 224 may be transmitted to a public network and the delay may be longer and include also additional encryption delays.

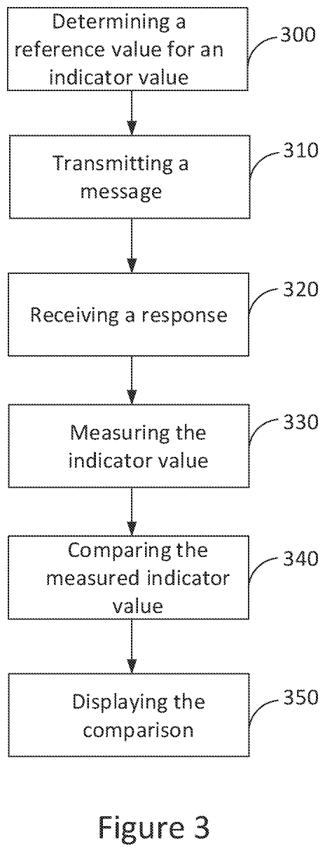

In FIG. 3 a flow chart of a method according to an example is shown. In the method the first step is to determine a reference value for the measured indicator value, step 300. The measured indicator value may be, for example, propagation time to a certain peripheral device or other component and back, availability of the peripheral device, capacity of the peripheral device and similar. The capacity of the peripheral device may be, for example, response time required for the task, overall processor load, memory occupancy and similar. The peripheral devices that can be used include destination control systems, access management systems and other similar devices that may be included in an elevator and escalator system.

The reference may be set based on a simulation or actual measurements. For example, the reference measurements may be done when the arrangement has been installed. The reference can be based on a plurality of measurements and set to be the average, mean or other value representing normal and acceptable operation level. The reference may also be remeasured, for example, when changes are made to the arrangement.

After the reference value has been determined the normal use of the method may be initiated. First, a message to a peripheral or a component is sent, step 310. This may be, for example, a call for an elevator that is made by an ordinary passenger. When the destination control system terminal sends a message for the call several measurements can be made, for example, how fast the message reaches the group controller and how fast the group controller is able to allocate the journey. The indicator value can be measured when a response is received, step 320. The response may be a response to the actual task or just an acknowledgement message, which can be used for measuring the network performance, step 330.

The process of transmitting messages, receiving responses and performing measurements are done continuously when users are placing calls and other tasks during the ordinary use of the elevator system. These measurements are typically stored for later use, for example, in a database or other data storage, that may be local or remote.

The measured values are then compared with the determined reference value, step 340. The comparison is done in order to determine the deviation from the reference value. It is normal that the measurement result deviates from the reference value. Thus, a threshold value may be set for the deviation. For example, if a normal deviation is within 2%, a threshold of 3% may be set. Furthermore, individual measurements may deviate even more without any serious problem as a reason. Thus, it is common that more than one measurement is collected for the comparison. The collection may be done, for example, time wise in a manner that indicator values of one day are collected and then the average is compared to the reference value.

In the following some examples of the measured indicator values are disclosed. An example of an indicator value is destination control system call time. When a DCS call allocation time is long/has grown from reference there may be a problem with group controllers. When DCS call availability is too low from at least some terminals, calls are lost. There may be a problem with group controllers or network.

When access request processing time is long/has grown from reference, there may a problem with access server/database performance. When the Internet connectivity/availability has dropped/is poor compared to reference, there may be a problem with internet gateway. When the building network availability has dropped/is poor compared to reference, the building network operator may have done some changes to the network that affect to the elevator and escalator network performance. When elevator operator cloud service availability has dropped/is poor compared to reference, there may be a problem with cloud gateway. When System temperatures are high in network elements, elevator controllers or other devices compared to reference, something may have changed happened in the system environment.

The indicator values and possible consequences discussed above are just examples and other similar indicator values may be added. Maintenance persons can see the state of the arrangement when measurement values are visualized with the reference values. Furthermore, as the measurement values represent both very small details and complete tasks in the arrangement a maintenance person can determine where the problem is. For example, when the call allocation time has increased significantly but there is no visible increase in the network propagation time, the maintenance person can concentrate on analyzing possible fault at a group controller.

The above-mentioned method may be implemented as computer software which is executed in a computing device which is capable of communicating with other devices. When the software is executed in a computing device it is configured to perform the above described inventive method. The software is embodied on a computer readable medium so that it can be provided to the computing device, such as the system controller 100 of FIG. 1.

As stated above, the components of the examples can include computer readable medium or memories for holding instructions programmed according to the teachings of the present embodiments and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the monitoring of elevator and escalator arrangement may be implemented in various ways. The monitoring of elevator and escalator arrangement and its embodiments are thus not limited to the examples described above; instead they may vary within the scope of the claims.

1. A method for measuring the state of an elevator and escalator arrangement comprising:
determining a reference value for an indicator value;
transmitting a message to a recipient component;
receiving a response to the transmitted message;
measuring the indicator value based on the received response;
comparing the measured indicator value with the reference value, wherein the comparison result is indicative of the state of a component in the elevator and escalator arrangement; and
displaying the comparison result in a user interface.

2. The method according to claim 1, wherein in the indicator value is a network delay between the requesting component and the serving component.

3. The method according to claim 1, wherein the indicator value is the delay required to perform a requested task at the serving component.

4. The method according to claim 1, wherein the indicator value is representing the availability of the component.

5. The method according to claim 1, wherein the indicator value is the resource load at the serving component.

6. The method according to claim 1, wherein the method further comprises displaying the comparison result as a relative deviation from the reference value.

7. The method according to claim 1, wherein the method further comprises comparing the comparing result with a threshold and as a response to exceeding the threshold, triggering an event.

8. The method according to claim 7, wherein the event is one of the following: a maintenance call or an alert.

9. A non-transitory computer readable medium storing computer program code, which is configured to cause performing a method according to claim 1, when executed by a computing device.

10. A system comprising a circuitry for executing computer programs, wherein the circuitry is configured to perform a method according to claim 1.

11. The method according to claim 2, wherein the method further comprises displaying the comparison result as a relative deviation from the reference value.

12. The method according to claim 3, wherein the method further comprises displaying the comparison result as a relative deviation from the reference value.

13. The method according to claim 4, wherein the method further comprises displaying the comparison result as a relative deviation from the reference value.

14. The method according to claim 5, wherein the method further comprises displaying the comparison result as a relative deviation from the reference value.

15. The method according to claim 2, wherein the method further comprises comparing the comparing result with a threshold and as a response to exceeding the threshold, triggering an event.

16. The method according to claim 3, wherein the method further comprises comparing the comparing result with a threshold and as a response to exceeding the threshold, triggering an event.

17. The method according to claim 4, wherein the method further comprises comparing the comparing result with a threshold and as a response to exceeding the threshold, triggering an event.

18. The method according to claim 5, wherein the method further comprises comparing the comparing result with a threshold and as a response to exceeding the threshold, triggering an event.

19. The method according to claim 6, wherein the method further comprises comparing the comparing result with a threshold and as a response to exceeding the threshold, triggering an event.

20. A non-transitory computer readable medium storing computer program code, which is configured to cause performing a method according to claim 2, when executed by a computing device.
